(19) United States
(12) Patent Application Publication
(10) Pub. No.: US 2018/0240371 A1
(43) Pub. Date: Aug. 23, 2018

(54) ELECTRONIC TAMPER DETECTION DEVICE

(71) Applicant: NXP B.V., Eindhoven (NL)

(72) Inventors: Christian Schwar, Graz (AT); Ronny Schomacker, Gratwein-Strassengel (AT)

(21) Appl. No.: 15/898,424

(22) Filed: Feb. 17, 2018

(30) Foreign Application Priority Data
Feb. 17, 2017 (EP) 17156632.6

(51) Int. Cl. G09F 3/03; G06K 19/077

(52) U.S. Cl. CPC G09F 3/0335; G06K 19/07798; G09F 3/0376

(57) ABSTRACT

According to a first aspect of the present disclosure, an electronic tamper detection device is provided, comprising a tamper loop, a processing unit and a storage unit, wherein the processing unit is configured to detect that the tamper loop is open and to store, if the tamper loop is open, data indicating that the tamper loop has been opened in said storage unit, wherein the storage unit is a non-volatile memory. According to a second aspect of the present disclosure, a corresponding tamper detection method is conceived. According to a third aspect of the present disclosure, a corresponding computer program is provided.

### FIELD

The present disclosure relates to an electronic tamper detection device. Furthermore, the present disclosure relates to a corresponding tamper detection method, and to a corresponding computer program.

### BACKGROUND

Electronic tamper detection devices may be used to detect tampering with closed or sealed products, such as bottles, packets and other containers. For example, in the spirits industry and the pharmaceutical industry such tamper detection devices may be useful. Tamper detection devices often contain a so-called tamper loop. A tamper loop may for example comprise a conductive wire that is broken when a closure or seal in which it is concealed is broken. Fre-quently used tamper detection devices are radio frequency identification (RFID) or near field communication (NFC) tags comprising or extended with a tamper loop. It may be desirable to improve these tamper detection devices.

### SUMMARY

According to a first aspect of the present disclosure, an electronic tamper detection device is provided, comprising a tamper loop, a processing unit and a storage unit, wherein the processing unit is configured to detect that the tamper loop has been opened and to store data indicating that the tamper loop has been opened in said storage unit, wherein the storage unit is a non-volatile memory.

In one or more embodiments, the processing unit is configured to store said data with added redundancy.

In one or more embodiments, the storage unit is configured to allow said data to be stored only once.

In one or more embodiments, the tamper detection device further comprises communication unit, the processing unit is configured to retrieve the stored data from the storage unit and to provide the retrieved data to the communication unit, and the communication unit is configured to transmit said retrieved data to an external device.

In one or more embodiments, the processing unit is configured to store said data during a start-up process of the tamper detection device.

In one or more embodiments, the processing unit is configured to store said data during a tamper loop status reporting process of the tamper detection device.

In one or more embodiments, the tamper loop comprises a conductive wire.

In one or more embodiments, the tamper detection device is a near field communication tag or a radio frequency identification tag.

In one or more embodiments, a closure comprises a tamper detection device of the kind set forth.

In one or more embodiments, a seal comprises a tamper detection device of the kind set forth.

According to a second aspect of the present disclosure, a tamper detection method is conceived, which uses an electronic tamper detection device, the tamper detection device comprising a tamper loop, a processing unit and a storage unit, wherein the storage unit is a non-volatile memory, and wherein the processing unit detects that the tamper loop has been opened and stores data indicating that the tamper loop has been opened in said storage unit.

According to a third aspect of the present disclosure, a computer program is provided, comprising non-transitory, executable instructions which, when executed by a processing unit, carry out or control a method of the kind set forth.

In one or more embodiments, a computer-readable medium comprises a computer program of the kind set forth.

### BRIEF DESCRIPTION OF THE DRAWINGS

Embodiments will be described in more detail with reference to the appended drawings, in which:

FIG. 1 shows an example of an electronic tamper detection device;

FIG. 2 shows an illustrative embodiment of a tamper detection device;

FIG. 3 shows an illustrative embodiment of a tamper detection method;

FIG. 4 shows another illustrative embodiment of a tamper detection method;

FIG. 5 shows a further illustrative embodiment of a tamper detection method;

FIG. 6 shows an illustrative embodiment of a communication between near field communication (NFC) devices.

### DESCRIPTION OF EMBODIMENTS

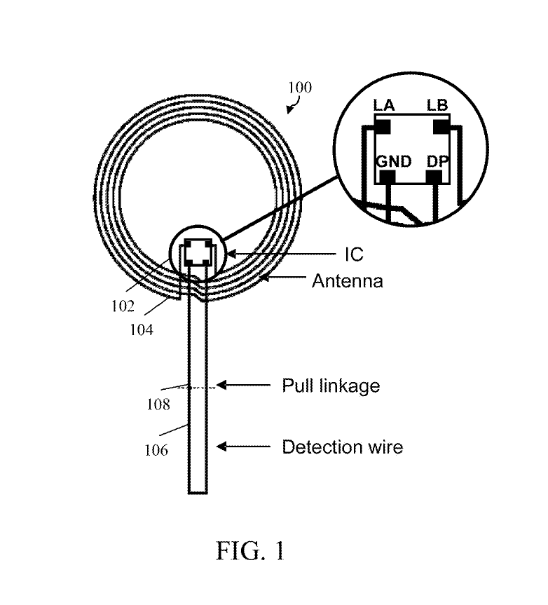

FIG. 1 shows an example of an electronic tamper detection device 100. In this example, the tamper detection device 100 is an RFID or NFC tag equipped with a tamper loop. The tag may be a so-called passive tag, i.e. a tag powered by an electromagnetic field generated by an external device (not shown). The tag comprises an integrated circuit 102 (i.e., a tag circuit) which is coupled through contact pads LA and LB to an antenna 104 for establishing wireless communication with said external device. The tamper loop is formed by a detection wire 106 (i.e., a conductive wire) which is coupled to the integrated circuit 102 through contact pads GND and DP. The detection wire 106 may for example be concealed in a closure comprising a pull linkage 108. In operation, once the detection wire 106 (tamper loop) has been opened (e.g., broken at the pull linkage 108) and the tag is powered by said electromagnetic field, the tag can detect the “Open” information and act accordingly. As used herein, “Open” information refers to information indicative of an opened (i.e., broken) tamper loop, while “Close” information refers to information indicative of a closed (i.e., unbroken) tamper loop.

As mentioned above, it may be desirable to improve these tamper detection devices. For example, a tag of the kind set forth contains a processing unit that performs a measurement on the tamper loop, and fetches the result of the measurement in a register. Such a register is often implemented using flip-flops. The detection of a tamper attempt, i.e. the detection of an open tamper loop, may not be available for retrieval for a sufficient amount time. Furthermore, the content of the register may be of a transient nature. Therefore, in accordance with the present disclosure, the processing unit of a tamper detection device is configured to detect that the tamper loop is open and to store, if the tamper loop is open, data indicating that the tamper loop has been opened in a non-volatile memory of the tamper detection device. In this way, the information on a detected tamper attempt is stored in a more persistent and reliable manner. A non-volatile memory is particularly suitable for storing the data which indicate that the tamper loop has been opened in a persistent and reliable manner. Examples of non-volatile memories are programmable read-only memories and flash memories. Furthermore, more detailed tamper detection reports can be created, as will explained in more detail below. Also, it is more difficult for an attacker to set the tamper detection device to a seemingly untampered state, i.e. a state in which the tamper loop appears to have never been opened, because both the direct result of the tamper measurement (e.g., the content of the register) and the data in the storage unit should be manipulated.

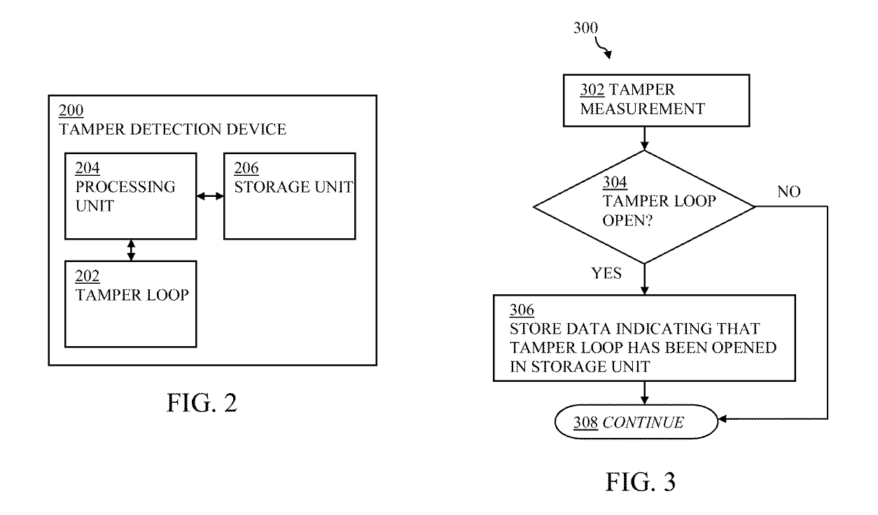

FIG. 2 shows an illustrative embodiment of a tamper detection device 200. The tamper detection device 200 comprises a tamper loop 202, a processing unit 204, and a storage unit 206. The storage unit 206 is a non-volatile memory. The processing unit 204 is operatively coupled to the tamper loop 202. In a practical and efficient implementation, the tamper loop 202 comprises a conductive wire (not shown). The processing unit 204 is configured to detect that the tamper loop 202 is open. The processing unit 204 may for example be configured to perform electrical measurements on the tamper loop 202, the result of which may be indicative of an open (or closed) tamper loop 202. Furthermore, the processing unit 204 is operatively coupled to the storage unit 206. Furthermore, the processing unit 204 is configured to store, if the tamper loop 202 is open, data indicating that the tamper loop 202 has been opened in the storage unit 206. It is noted that the data indicating that the tamper loop 202 has been opened is referred to as “Recall Open” information herein.

FIG. 3 shows an illustrative embodiment of a tamper detection method 300. The tamper detection method 300 comprises, at 302, a tamper measurement performed by the processing unit 204 shown in FIG. 1. As mentioned above, the processing unit 204 may for example be configured to perform electrical measurements on the tamper loop 202, the result of which may be indicative of an open (or closed) tamper loop 202. At 304, a decision is taken. If the tamper loop is open, then the method proceeds to step 306. If the tamper loop is not open, then the method proceeds to step 308, in which the process continues with other operations (e.g., trans-mitting a response to a tamper detection status inquiry). At 306, the processing unit 204 stores data indicating that the tamper loop 202 has been opened in the storage unit 206. The method 300 may be carried out or controlled by a computer program.

It may be desirable to store said data in a fail-safe manner. This may be achieved in different ways. In some embodiments, the processing unit 204 is configured to store said data with added redundancy. Adding redundancy refers to the process of storing the same data multiple times. For example, the data may be stored two times in independent memory locations. In case the data is lost at one of the locations (e.g. after a couple of years), the data is still available, and the memory location where the data is lost may be refreshed using the data at the other location. In this way, loss of “Recall Open” information over the lifetime of the tamper detection device 200 may be avoided. Furthermore, in some embodiments, the storage unit 206 is configured to allow said data to be stored only once. In this way, a subsequent write attempt to the data's location will fail, so that the data cannot be overwritten. Thus, the proba-bility that the data is lost is reduced. Furthermore, this makes it difficult for an attacker to reset the tamper detection device 200 to a seemingly untampered state.

Furthermore, in one or more embodiments, the tamper detection device further comprises a communication unit (not shown), and the processing unit is configured to retrieve the stored data from the storage unit and to provide the retrieved data to the communication unit. Furthermore, the communication unit is configured to transmit the received data to an external device. For the example, the communication unit may be an near field communication (NFC) unit or a radio frequency identification (RFID) unit. In this way, the stored data may be retrieved easily by an NFC reader or RFID reader. In some embodiments, the tamper detection device is an NFC tag or an RFID tag. NFC tags and RFID tags are relatively simple devices that can easily be embedded into tamper-sensitive products. In some embodiments, a closure comprises the tamper detection device. In other embodiments, a seal comprises the tamper detection device. In this way, detecting the tampering with closed or sealed products, such as bottles, packets and other containers, is facilitated.

In a practical and efficient implementation, an NFC or RFID tag contains an integrated circuit (i.e., a chip) that is able to detect a tamper event. More specifically, the chip contains a processing unit that is configured to test whether a tamper loop (e.g., a conductive wire) has been broken or not. When the processing unit detects that the tamper loop is open (i.e., when it detects the “Open” information), it stores data indicating that the tamper loop has been opened (i.e., the “Recall Open” information) in a non-volatile memory for later use. This storage may be done in a fail-safe manner, for example by adding redundancy and/or as a one-time-programmable memory access. Using a communication unit, the chip can report both kinds of information (i.e., the “Open” or “Close” information, as well as the “Recall Open” information). For instance, the chip may report the information in a response to a dedicated command, or as part of a standardized message such as an NFC data exchange format (NDEF) message. Table I shows that the two kinds of tamper information enable different interpreta-tions of the tamper status, which in turn enables creating more detailed tamper detection reports.

TABLE 1

| Tamper loop | “Recall Open” in | |
|---|---|---|
| “Open” | memory | Interpretation |
| no | no | no tamper event detected |
| yes | no | tamper wire has been broken the |
| | | first time |
| yes | yes | tamper wire has been broken |
| | | more than one time |
| no | yes | tamper wire has been broken and |
| | | re-connected |

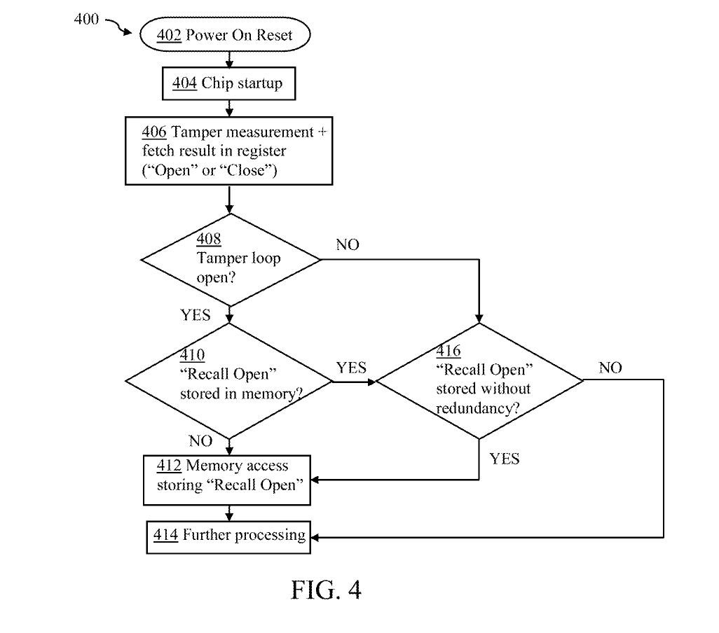

FIG. 4 shows another illustrative embodiment of a tamper detection method 400. In one or more embodiments, the processing unit is configured to store the data during a start-up process of the tamper detection device. Such a start-up process is shown in FIG. 4. In particular, the tamper detection method 400 comprises, at 402, initiating a Power On Reset of the chip of the tamper detection device. Then, at 404, the chip starts up. At 406, the processing unit performs a tamper measurement and fetches the result of the measurement (“Open” or “Close”) in a register. The register may have been implemented using flip-flops. At 408, a decision is taken: if the tamper loop is open, the method 400 proceeds to step 410; otherwise, the method 400 proceeds to step 414. At 410, another decision is taken: if the “Recall Open” information (i.e., the data indicating that the tamper loop has been opened) is already present in the memory, the method 400 proceeds to step 416; otherwise, the method 400 proceeds to step 412. At 416, another decision is taken: if the “Recall Open” information has already been stored in the memory, but without added redundancy, the method 400 proceeds to step 412; otherwise, the method 400 proceeds to step 414. Step 416 enables, among others, a refresh of the “Recall Open” information in the memory in cases where the tamper loop has been reconnected and the previously stored redundant “Recall Open” information is lost. At 412, the “Recall Open” information is stored in the memory. At 414, the chip may continue with other operations.

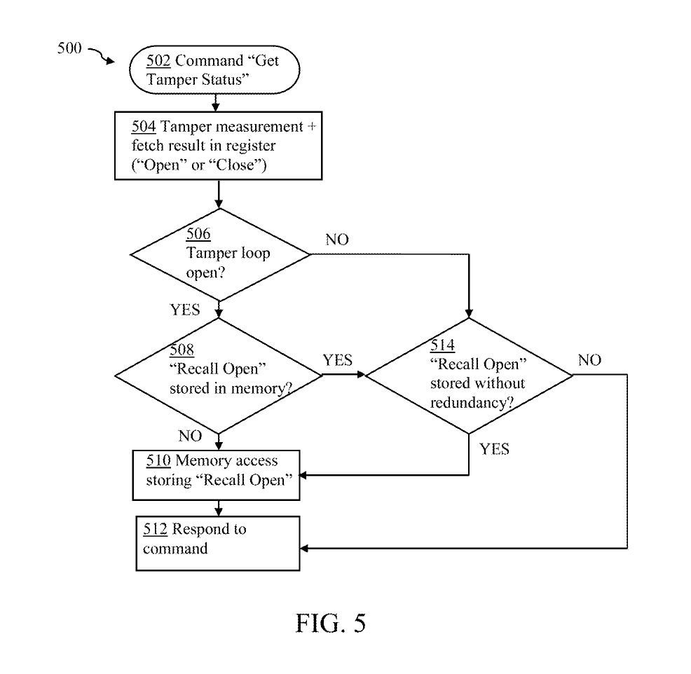

FIG. 5 shows a further illustrative embodiment of a tamper detection method 500. In one or more embodiments, the processing unit is configured to store the data during a tamper loop status reporting process of the tamper detection device. Such a tamper loop status reporting process is shown in FIG. 5. In particular, the tamper detection method 500 comprises, at 502, receiving, by the processing unit via the communication unit, a “Get Tamper Status” command from an external device. Then, at 504, the processing unit performs a tamper measurement and fetches the result of the measurement (“Open” or “Close”) in a register. The register may have been implemented using flip-flops. At 506, a decision is taken: if the tamper loop is open, the method 500 proceeds to step 508; otherwise, the method 500 proceeds to step 512. At 508, another decision is taken: if the “Recall Open” information (i.e., the data indicating that the tamper loop has been opened) is already present in the memory, the method 500 proceeds to step 514; otherwise, the method 500 proceeds to step 510. At 514, another decision is taken: if the “Recall Open” information has already been stored in the memory, but without added redundancy, the method 500 proceeds to step 510; otherwise, the method 500 proceeds to step 512. At 510, the “Recall Open” information is stored in the memory. At 512, the processing unit responds to the command via the communication unit.

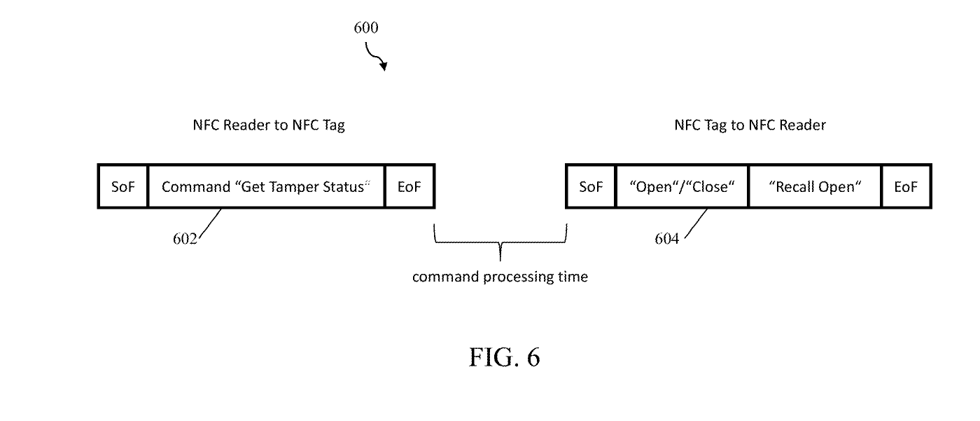

FIG. 6 shows an illustrative embodiment of a communication 600 between near field communication (NFC) devices. The communication 600 comprises a “Get Tamper Status” command message 602 which is transmitted by an NFC reader to an NFC tag. The message 602 comprises a frame having a first portion (Start of Frame, SoF), a second portion (a “Get Tamper Status” command), and a third portion (End of Frame, EoF). Furthermore, the communication 600 comprises a response message 604 which is transmitted by the NFC tag to the NFC reader. The message 604 comprises a frame having a first portion (Start of Frame, SoF), a second portion (the “Open” or “Close” information), a third portion (the “Recall Open” information), and a fourth portion (End of Frame, EoF). It is noted that the transmission of message 602 may precede step 502 of the tamper detection method 500 shown in FIG. 5. Furthermore, the message 604 may transmitted during step 512 of the tamper detection method 500 shown in FIG. 5.

The systems and methods described herein may at least partly be embodied by a computer program or a plurality of computer programs, which may exist in a variety of forms both active and inactive in a single computer system or across multiple computer systems. For example, they may exist as software program(s) comprised of program instructions in source code, object code, executable code or other formats for performing some of the steps. Any of the above may be embodied on a computer-readable medium, which may include storage devices and signals, in compressed or uncompressed form.

As used herein, the term “mobile device” refers to any type of portable electronic device, including a cellular telephone, a Personal Digital Assistant (PDA), smartphone, tablet etc. Furthermore, the term “computer” refers to any electronic device comprising a processor, such as a general-purpose central processing unit (CPU), a specific-purpose processor or a microcontroller. A computer is capable of receiving data (an input), of performing a sequence of predetermined operations thereupon, and of producing thereby a result in the form of information or signals (an output). Depending on the context, the term “computer” will mean either a processor in particular or more generally a processor in association with an assemblage of interrelated elements contained within a single case or housing.

The term “processor” or “processing unit” refers to a data processing circuit that may be a microprocessor, a co-processor, a microcontroller, a microcomputer, a central processing unit, a field programmable gate array (FPGA), a programmable logic circuit, and/or any circuit that manipulates signals (analog or digital) based on operational instructions that are stored in a memory. The term “memory” refers to a storage circuit or multiple storage circuits such as read-only memory, random access memory, volatile memory, non-volatile memory, static memory, dynamic memory, Flash memory, cache memory, and/or any circuit that stores digital information.

As used herein, a “computer-readable medium” or “storage medium” may be any means that can contain, store, communicate, propagate, or transport a computer program for use by or in connection with the instruction execution system, apparatus, or device. The computer-readable medium may be, for example but not limited to, an electronic, magnetic, optical, electromagnetic, infrared, or semiconductor system, apparatus, device, or propagation medium. More specific examples (non-exhaustive list) of the computer-readable medium may include the following: an electrical connection having one or more wires, a portable computer diskette, a random access memory (RAM), a read-only memory (ROM), an erasable programmable read-only memory (EPROM or Flash memory), an optical fiber, a portable compact disc read-only memory (CDROM), a digital versatile disc (DVD), a Blu-ray disc (BD), and a memory card.

It is noted that the embodiments above have been described with reference to different subject-matters. In particular, some embodiments may have been described with reference to method-type claims whereas other embodiments may have been described with reference to apparatus-type claims. However, a person skilled in the art will gather from the above that, unless otherwise indicated, in addition to any combination of features belonging to one type of subject-matter also any combination of features relating to different subject-matters, in particular a combination of features of the method-type claims and features of the apparatus-type claims, is considered to be disclosed with this document.

Furthermore, it is noted that the drawings are schematic. In different drawings, similar or identical elements are provided with the same reference signs. Furthermore, it is noted that in an effort to provide a concise description of the illustrative embodiments, implementation details which fall into the customary practice of the skilled person may not have been described. It should be appreciated that in the development of any such implementation, as in any engi-neering or design project, numerous implementation-specific decisions must be made in order to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill.

Finally, it is noted that the skilled person will be able to design many alternative embodiments without departing from the scope of the appended claims. In the claims, any reference sign placed between parentheses shall not be construed as limiting the claim. The word “comprise(s)” or “comprising” does not exclude the presence of elements or steps other than those listed in a claim. The word “a” or “an” preceding an element does not exclude the presence of a plurality of such elements. Measures recited in the claims may be implemented by means of hardware comprising several distinct elements and/or by means of a suitably pro-grammed processor. In a device claim enumerating several means, several of these means may be embodied by one and the same item of hardware. The mere fact that certain measures are recited in mutually different dependent claims does not indicate that a combination of these measures cannot be used to advantage.

### LIST OF REFERENCE SIGNS

100 tamper detection device
102 integrated circuit
104 antenna
106 detection wire
108 pull linkage
200 tamper detection device
202 tamper loop
204 processing unit
206 storage unit
300 tamper detection method
302 tamper measurement
304 tamper loop open?
306 store data indicating that tamper loop has been opened in storage unit
308 continue
400 tamper detection method
402 Power On Reset
404 chip startup
406 tamper measurement and fetch result in register (“Open” or “Close”)
408 tamper loop open?
410 “Recall Open” stored in memory?
412 memory access storing “Recall Open”
414 further processing
416 “Recall Open” stored without redundancy?
500 tamper detection method
502 command “Get Tamper Status”
504 tamper measurement and fetch result in register (“Open” or “Close”)
506 tamper loop open?
508 “Recall Open” stored in memory?
510 memory access storing “Recall Open”
512 respond to command
514 “Recall Open” stored without redundancy?
600 communication between NFC devices
602 command
604 response to command

1. An electronic tamper detection device comprising a tamper loop, a processing unit and a storage unit, wherein the processing unit is configured to detect that the tamper loop is open and to store, if the tamper loop is open, data indicating that the tamper loop has been opened in said storage unit, wherein the storage unit is a non-volatile memory.

2. The tamper detection device of claim 1, wherein the processing unit is configured to store said data with added redundancy.

3. The tamper detection device of claim 1, wherein the storage unit is configured to allow said data to be stored only once.

4. The tamper detection device of claim 1, further comprising a communication unit, wherein the processing unit is configured to retrieve the stored data from the storage unit and to provide the retrieved data to the communication unit, and wherein the communication unit is configured to transmit said retrieved data to an external device.

5. The tamper detection device of claim 1, wherein the processing unit is configured to store said data during a start-up process of the tamper detection device.

6. The tamper detection device of claim 1, wherein the processing unit is configured to store said data during a tamper loop status reporting process of the tamper detection device.

7. The tamper detection device of claim 1, wherein the tamper loop comprises a conductive wire.

8. The tamper detection device of claim 1, being a near field communication tag or a radio frequency identification tag.

9. A closure comprising the tamper detection device of claim 1.

10. A seal comprising the tamper detection device of claim 1.

11. A tamper detection method using an electronic tamper detection device, the tamper detection device comprising a tamper loop, a processing unit and a storage unit, wherein the storage unit is a non-volatile memory, and wherein the processing unit detects that the tamper loop is open and stores data indicating that the tamper loop has been opened in said storage unit.

12. A computer program comprising non-transitory, executable instructions which, when executed by a processing unit, carry out or control the method of claim 11.

13. A computer-readable medium comprising the computer program of claim 12.
